(19) United States
(12) Patent Application Publication
(10) Pub. No.: US 2023/0085702 A1
(43) Pub. Date: Mar. 23, 2023

(54) COFFEE ROASTING SYSTEM WITH ROASTING AND COOLING SUBSYSTEMS

(71) Applicant: Bellwether Coffee Co., Berkeley, CA (US)

(72) Inventors: Stewart SCHMEHL, Pinehurst, NC (US); John SANDHU, Boulder, CO (US)

(21) Appl. No.: 17/482,858

(22) Filed: Sep. 23, 2021

(51) Int. Cl. A23N 12/08; F24C 15/32; F24C 15/04; A23N 12/12; A23F 5/04; B01F 7/00; B01F 15/06

(52) U.S. Cl. CPC A23N 12/083; F24C 15/322; F24C 15/04; A23N 12/125; A23F 5/04; B01F 7/0065; B01F 15/063; B01F 2015/062; B01F 2215/0013

(57) ABSTRACT

A bean roasting system includes a roasting subsystem and an air handling subsystem. The roasting subsystem includes a housing, an agitator actuator, an agitator, a bearing and a door. The housing has an inner surface defining an inner chamber for holding a batch of beans during a thermal roasting process. The agitator is coupled to the agitator actuator and includes a central shaft and a blade set mounted to the central shaft. The bearing supports the central shaft and is configured to prevent the blade set from contacting the inner surface of the housing. The door has a transparent window to allow viewing of the thermal roasting process. The air handling system is coupled to the roasting subsystem, includes a blower and heater, and is configured to circulate heated air through the roasting subsystem during the thermal roasting process.

### CROSS-REFERENCE TO RELATED APPLICATIONS

The present is related to U.S. patent application Ser. No. 17/391,579 entitled “Coffee Roasting System with Roasting and Cooling Subsystems, and Methods for the Same” and filed on Aug. 2, 2021; U.S. patent application Ser. No. 17/391,581 entitled “Coffee Roasting System with Roasting and Cooling Subsystems, and Methods for the Same” and filed on Aug. 2, 2021; and US patent application attorney docket number BWCC-011/00US entitled “Coffee Roasting System with Roasting and Cooling Subsystems, and Methods for the Same” and filed herewith; the contents of each of which is incorporated by reference in their entireties.

### FIELD OF THE DISCLOSURE

The present disclosure pertains to the roasting of food products, particularly to beans, and more particularly to coffee beans. Yet more particularly, the present disclosure describes an automated roasting system having a compact roasting subsystem that maximizes uniformity of roasting and allows viewing of the roasting process.

### BACKGROUND

Food roasting machines are in wide use. One particularly common roasting machine is utilized to prepare coffee beans to be either packaged or ground and brewed. A typical roasting machine includes a roasting chamber for supporting, agitating, and roasting beans. One challenge is to provide a compact roasting system while providing very uniform roasting and allow viewing of the roasting process.

### BRIEF DESCRIPTION OF THE FIGURES

FIG. 1 is a schematic diagram of an embodiment of a roasting system for processing a batch of coffee beans. FIG. 1 illustrates connections between elements that are either fluidic connections or concern a physical transfer of a batch of beans.

FIG. 2 is a simplified electrical block diagram for the roasting system of FIG. 1. FIG. 2 illustrates electrical or wireless connections between elements including a controller.

FIG. 3 is a flowchart of an embodiment of a roasting process for a batch of beans.

FIG. 4 is an isometric view of an embodiment of a roasting subsystem.

FIG. 5 is a cross-sectional view of an embodiment of a roasting subsystem.

FIG. 6 is side view of an embodiment of an agitator coupled to a bearing in isolation.

FIG. 7 is an isometric view of an embodiment of an agitator coupled to an agitator actuator in isolation.

FIG. 8 is a flowchart of an embodiment of a method of operating a roasting system.

### SUMMARY

In a first aspect of the disclosure, a bean roasting system includes a roasting subsystem and an air handling subsystem. The roasting subsystem includes a housing, an agitator actuator, an agitator, a bearing and a door. The housing has an inner surface defining an inner chamber for holding a batch of beans during a thermal roasting process. The inner chamber has a horizontal axis. The agitator is coupled to the agitator actuator and includes a central shaft and a blade set mounted to the central shaft. The bearing is disposed at a rear end portion of the housing. The bearing supports the central shaft and is configured to prevent the blade set from contacting the inner surface of the housing. The door has a transparent window disposed at a front end portion of the housing. The transparent window is configured to allow viewing of the inner chamber during the thermal roasting process. The air handling system is coupled to the roasting subsystem, includes a blower and heater, and is configured to circulate heated air through the roasting subsystem during the thermal roasting process. The roasting subsystem provides a very uniform roast for the batch of beans which can be viewed through the transparent window. The roasting subsystem is also very compact while holding a large batch of beans.

In one implementation, the housing includes a first conduit defining an air inlet and a second conduit defining an air outlet and a bean inlet. The first conduit can be located adjacent to the rear end portion of the housing and configured to receive heated air flow in a vertically downward direction from the air handling subsystem. The second conduit can be located adjacent to the front end portion of the housing and configured to output air flow in a vertically upward direction to the air handling subsystem. The second conduit can have a larger cross sectional area than the first conduit and is can be configured to slow down a rate of airflow into the air handling subsystem in an upward direction to reduce entrainment of the batch of beans into the air handling subsystem. The second conduit is also configured to receive an unroasted batch of beans from a hopper.

In another implementation, the housing includes a hatch. The blade set can be configured to impart a stirring motion of the batch of beans to facilitate exit of the batch of beans through the hatch when the batch of beans is being unloaded from the chamber. The stirring motion can include back and forth horizontal components.

In yet another implementation, the blade set can include an inner spiral auger and an outer set of blades. The inner spiral auger is configured to impart a horizontal motion of the batch of beans along a first horizontal direction. The outer set of blades is configured to impart a horizontal motion of beans along a second horizontal direction that opposes the first horizontal direction to enhance mixing of the batch of beans during the thermal roasting process. The blade set can include a plurality of radial spokes that support the outer set of blades outside of the inner spiral auger. This blade configuration and imparted motion also enhances efficiency and completeness when unloading beans.

In a further implementation, the central shaft is a hollow cylindrical shaft. The bearing radially surrounds the hollow cylindrical shaft at the rear end portion of the housing. This structure enables full support of the blade set without a separate support bearing at a front end portion of the housing.

In a yet further implementation, the agitator actuator includes a motor and a power coupling mounted behind the rear end portion of the housing. The power coupling is configured to transfer rotational power from the motor to the agitator. The motor extends in a frontward direction from the power coupling and overlaps with the housing along the horizontal axis. This structure provides an efficient rotational power delivery to the agitator in a compact structure of the roasting subsystem.

In another implementation, the bean roasting system includes a hopper, a bean cooling subsystem, and a controller. The controller is configured to operate the hopper to release the batch of beans from the hopper to the inner chamber, operate the agitator actuator to rotate the actuator and to stir the batch of beans within the inner chamber, operate the air handling subsystem to circulate heated air through the inner chamber according to the thermal roasting process, and operate the bean release actuator and the agitator actuator to release beans from the inner chamber to the bean cooling subsystem.

### DETAILED DESCRIPTION

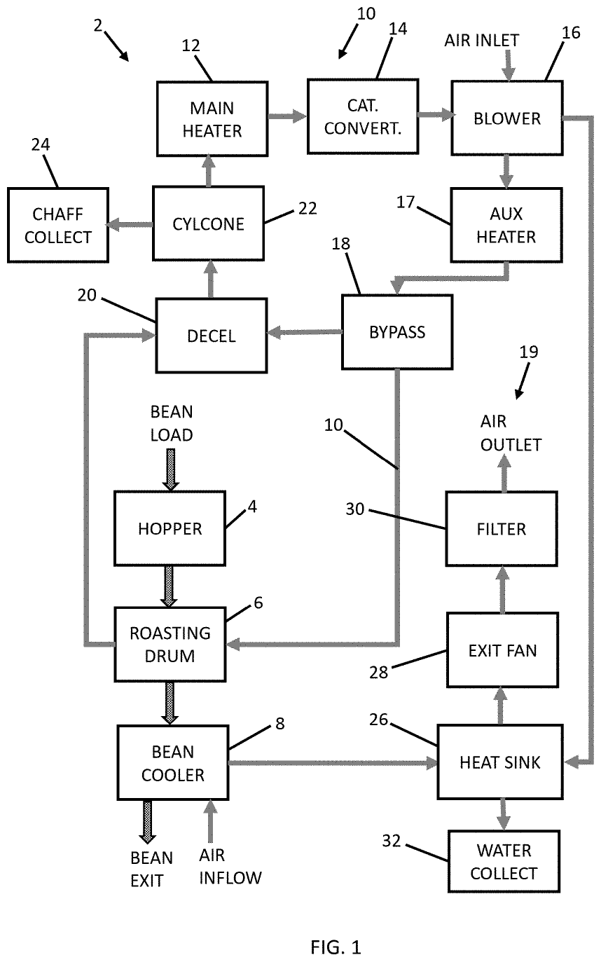

FIG. 1 is a schematic diagram of an embodiment of a roasting system 2. FIG. 1 discloses fluid paths between various functional elements. The fluid paths tend to conduct gaseous fluids such as air, water vapor, and gaseous emissions from beans being roasted or cooled. In addition, particulates from the roasting process can also be transmitted or entrained through the fluid paths. FIG. 1 also discloses a path for a batch of beans from a bean load to a bean exit.

Roasting system 2 includes a hopper 4 for loading and receiving a quantity or batch of unroasted beans. The hopper 4 feeds the unroasted beans into a roasting drum 6 or roasting subsystem 6 within which the batch of beans is heated and roasted, for example, according to a pre-programmed roasting process. Adjacent or below the roasting drum 6 is a bean cooling subsystem 8 or bean cooler 8 for receiving the batch of beans when they are in a just-roasted state (still hot), holding the batch of beans until they are cooled, and then dispensing the batch of beans into a receiving container such as a bag (not shown).

The roasting drum 6 is coupled to an air handling system 10 that includes a main heater 12, a catalytic converter 14, a blower 16, an auxiliary heater 17, a bypass 18, a velocity decelerator 20, a cyclone separator 22, and chaff collector 24. The air handling system 10 determines a temperature versus time roasting profile through controlled operation of the main heater 12, blower 16, auxiliary heater 17, bypass 18, and possibly other components of the air handling system 10. An air stream (indicated by arrows) recirculates through the air handling system 10. The air handling system 10 receives and removes particles and gaseous effluents emitted during the roasting process. The particles are captured by the cyclone 22, which deposits them in the chaff collector 24, which is periodically emptied. The gaseous effluents are collected by the catalytic converter 14.

The air handling system 10 defines two different branches or loops of air flow that are coupled by the bypass 18. One branch circulates from the bypass 18 to a decelerator 20, through the cyclone 22, main heater 12, catalytic converter 14, blower 16, and auxiliary heater 17, before returning to the bypass 18. Another branch passes from the bypass 18 to the roasting drum 6, to the decelerator 20, the cyclone 22, main heater 12, catalytic converter 14, blower 16, and auxiliary heater 17, before returning to bypass 18.

Part of an airstream generated by the blower 16 passes through an air exit subsystem 19 including a heat sink 26, an exit fan 28, and a filter 30 before being passed to environmental air (labeled as “air outlet” in FIG. 1). The heat sink 26 has the effect of condensing water vapor from the exit airstream as well as cooling the exit airstream. The condensed water vapor drips into a water collection receptacle 32. Replacement air (labeled “air inlet” in FIG. 1) from the environment air enters the blower 16. The overall effect is to remove water vapor from the air handling system 10 and to condense the water into the water collection receptacle 26.

The bean cooler 8 is also coupled to the air exit subsystem 19. The exit fan 28 therefore draws air out of the bean cooler 8 through the heat sink 26. This has the effect of accelerating cooling of the batch of beans.

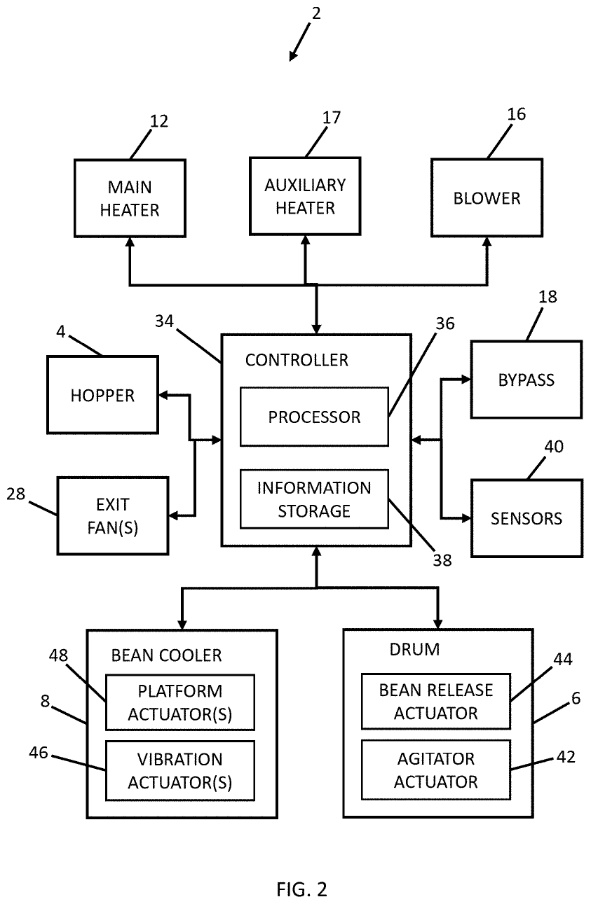

FIG. 2 is a simplified electrical block diagram of the roasting system 2. Relative to FIG. 1, like element numbers refer to like components. However, whereas FIG. 1 focuses on fluidics and the physical motion of beans, FIG. 2 focuses on electrical or wireless connections between components.

A controller 34 includes a processor 36 coupled to an information storage device 38. The information storage device 38 is a non-volatile or non-transient information storage device 38 that stores software instructions. When executed by the processor 36, the software instructions can control portions of the roasting system 2 that the controller 34 is configured to control. For example, the controller 34 can control any of the hopper 4, drum 6, bean cooler 8, main heater 12, blower 16, auxiliary heater 17, bypass 18, exit fan(s) 28, and other portions of the roasting system 2. The controller 34 can receive information from one or more sensors 40 for monitoring a status of portions of roasting system 2. The controller 34 is configured to control various actuators including an agitator actuator 42, a bean release actuator 44, a vibration actuator 46, and a platform actuator 48.

The agitator actuator 42 is configured to agitate the batch of beans within the drum 6 during the roasting process. The bean release actuator 44 is configured to release the batch of beans after roasting so that they can enter the bean cooler 8. The vibration actuator 46 is configured to vibrate the batch of beans and to enhance uniformity and rate of cooling of the batch of beans. The platform actuator 48 is configured to release the batch of beans after cooling to be dispensed into a container or bag.

In an embodiment, the agitator actuator 42 is configured to rotate an agitator. The agitator can include an agitator blade set supported by a central shaft. The agitator actuator can include a motor and a power coupling that couples the motor to the central shaft. The power coupling can include a gearbox and/or a belt that provides rotative coupling between the motor and the central shaft. In an embodiment, the bean release actuator 44 includes a pneumatic cylinder configured to open and close a hatch formed into a lower surface of the drum 6.

In an embodiment, the vibration actuator 46 can include a motor coupled to an elliptical cam or gear that couples to and shakes a cooling platform, which in turn supports a batch of beans while cooling. In other embodiments the vibration actuator 46 can take other forms such as a motor with an elliptical weight or a piezoelectric transducer stack. In an embodiment, the platform actuator 48 can include one or more pneumatic cylinders configured to open and close an opening in the cooling platform.

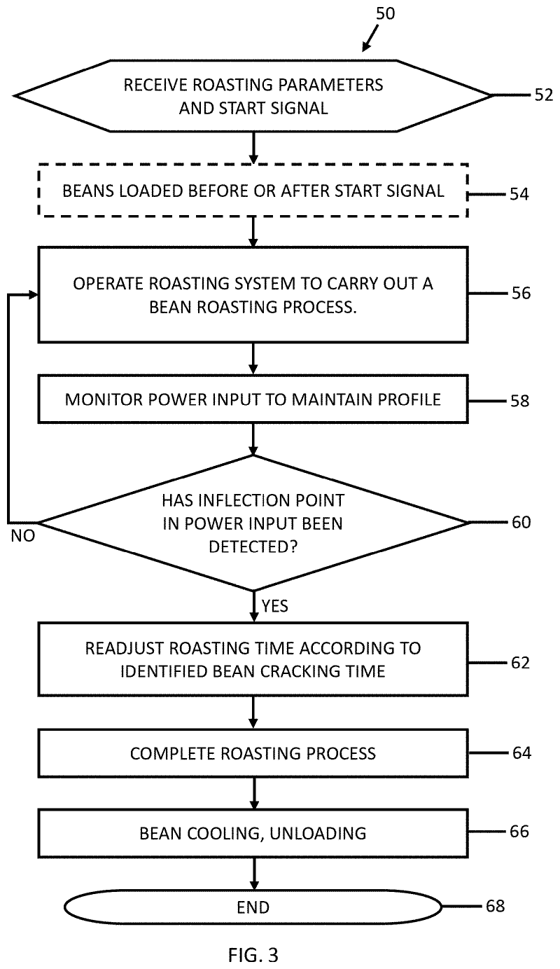

FIG. 3 is a flowchart of an embodiment of a roasting process 50 that is controlled by the controller 34. According to 52, controller 34 receives roasting parameters and a start signal. The roasting parameters can be indicative of a temperature-versus-time profile for roasting. The roasting parameters may also include a temperature profile before and after a bean cracking event is detected.

According to 54, a batch of beans is automatically or manually loaded into the hopper 4. Step 54 is showed in a dashed outline to highlight that it can be performed before or after step 52.

According to step 56, the roasting system 10 is operated to agitate and heat the batch of beans to begin and executing a bean roasting process. Executing the roasting process includes more particular processes including (1) operating the hopper to release the batch of beans into the drum, (2) operating the agitator actuator 42 to begin stirring and agitating the batch of beans, and (3) operating the air handling system 10 to heat the drum and to remove byproducts of the roasting process. The temperature in the drum ramps up and then stabilizes at a roasting temperature.

According to 58, a power used by the air handling system 10 to maintain the roasting temperature (by heating the drum) is monitored. The power is used to compensate for heat losses from the air handling system as well as a phase change that occurs as water is released from the batch of beans. The power usage will tend to be fairly stable and to drop during roasting initially. However, when the beans begin cracking, an exposure of water from within the beans will result in the air handling system 10 using more power to compensate for a phase change in the water from liquid to gaseous phase. The controller will then detect an increase in the power input in step 58. This increase in power is referred to as an “inflection point” in the monitored power level.

According to 60, detection of the inflection point in power level causes the process to proceed to step 62. Otherwise, the process loops back to steps 56 and 58 to continue to maintain the roasting temperature and monitor the input power.

Once the inflection point is determined, the controller 34 computes or determines a remaining temperature profile (temperature versus time) to complete the roasting process according to step 62. According to step 64, the controller applies the determined remaining temperature profile to the batch of beans.

According to 66, the controller controls the drum 6 and bean cooler 8 to cool and release the batch of beans. This ends at step 68 with the beans released into a container such as a bag.

In the forgoing description, mutually orthogonal axes X, Y, and Z will be used. The Z-axis is generally vertical and generally aligned with a gravitational reference. By “generally” it is by design but may vary according to manufacturing tolerances. The X-axis and Y-axis are generally horizontal and lateral.

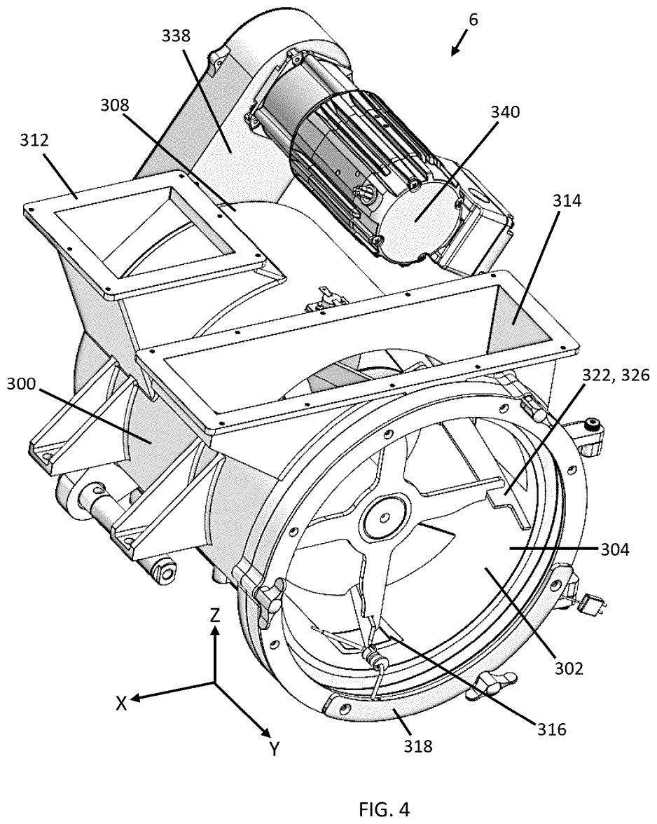

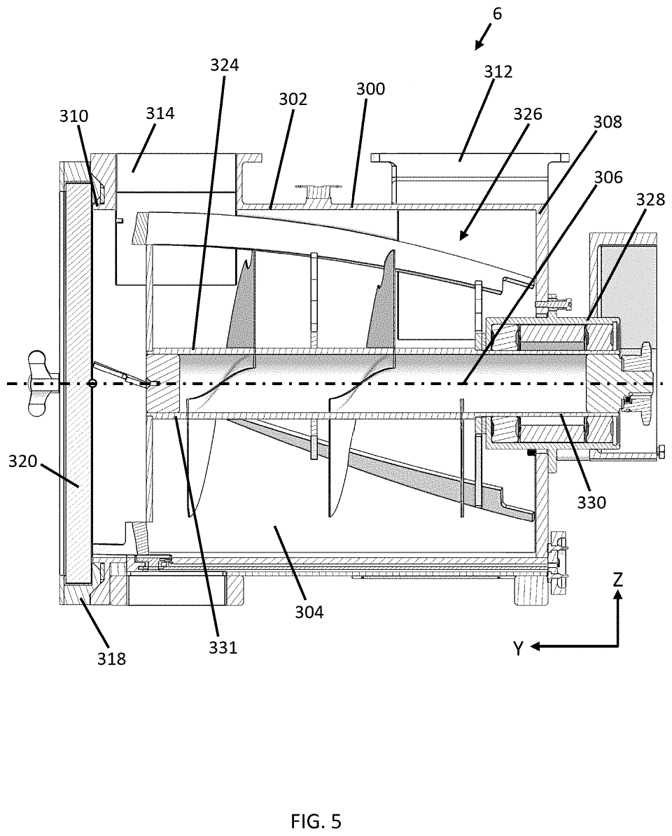

FIGS. 4 and 5 are isometric and cross-sectional views of an embodiment of a roasting subsystem 6 respectively. Roasting subsystem 6 includes a housing 300 having an inner surface 302. The inner surface 302 defines a chamber 304 for holding the batch of beans during a thermal roasting process. The housing 300, inner surface 302 and chamber 304 have a common horizontal axis 306. The housing 300 has a rear end portion 308 and a front end portion 310 with respect to the horizontal axis 306. As shown in FIGS. 4 and 5, the housing 300, inner surface 302 and chamber 304 each can have substantially cylindrical shape.

The bean roasting subsystem 6 includes a first conduit 312, which is adjacent to the rear end portion 308 of the housing 300 and functions as an air inlet. As shown in FIG. 1, heated air from the air handling system 10 enters the first conduit 312 and then enters the chamber 304 in a vertically downward (−Z) direction.

A second conduit 314 is adjacent to the front end portion 310 of the housing 300. The second conduit 314 functions as an air outlet and a bean inlet. A batch of beans is loaded from the hopper 4, through the second conduit 314 and into the chamber 304. Air from the chamber 304 exits from the second conduit 314 in an upward direction and then passes to cyclone 22 (see also FIG. 1). The second conduit 314 has a larger cross sectional area than the first conduit 312 to slow down a velocity of air exiting upward to avoid entraining beans but with a velocity to entrain smaller effluent particles to be removed by the cyclone 22.

The housing 300 includes a hatch 316 configured for unloading the batch of beans after the roasting process is complete. The hatch 316 is along a lower portion of the housing 300 and above the bean cooler 8. The hatch 316 is coupled to the bean release actuator 44. The bean release actuator 44 is configured to swing or move the hatch 316 between two positions—a closed position at which the hatch 316 is flush with a lower portion of the inner surface 302 and an open position at which the hatch 316 is lowered below the inner surface 302 to allow beans to fall into the bean cooling subsystem 8.

A door 318 having a transparent window 320 is mounted to the front end portion 310 of the housing 300. The door 318 is configured to be opened from a closed state to allow a front access to the chamber 304. The transparent window 320 is a large circular transparent plate to allow viewing of the chamber 304 during a roasting process. The transparent window 320 can be formed from a high temperature glass, a quartz, or other high temperature and transparent material.

Positioned within the chamber 304 is an agitator 322. Agitator 322 includes a central shaft 324 coupled to a blade set 326. The central shaft 324 is hollow cylindrical shaft 324 and is configured to rotate about the horizontal axis 306. Mounted to the rear end portion 308 of the housing 300 is a bearing 328 that surrounds and rotatively supports a rear portion 330 of the central shaft 324.

The combination of the bearing 328 and the hollow cylindrical shaft 324 is configured to provide support to maintain a spacing between the blade set 326 and the inner surface 302 of the housing 300 without any axial bearing support at a front portion 331 of the central shaft 324. For example, the bearing 328 can be sized and configured to support the weight of the hollow cylindrical shaft 324 in a cantilevered position. As such, in implementations where the cylindrical shaft 324 presents a greater moment arm (e.g., due to a larger outer radius, smaller inner radius, longer length and/or greater weight) than for other implementations, then the bearing 328 can have a greater length (along the horizontal axis 306) and/or stiffness than would be the case for other implementations. Although the cylindrical shaft 324 is described as being hollow, it should be understood that in different embodiments, the cylindrical shaft can be solid. Whether the cylindrical shaft is hollow or solid, and depending on the material(s) used to form the cylindrical shaft, the cylindrical shaft will present a certain moment arm and the bearing 328 will be sized and configured to support the weight of the cylindrical shaft in a cantilevered position.

For another example, the bearing 328 can be sized and configured as a function of the location of the bearing 328 relative to the rear portion of the housing 300. In particular, the more that a portion the bearing 328 is disposed within the chamber 302, the more that the portion of the bearing 328 will be subject to the higher temperatures within the chamber 302. As such, the bearing 328 can be configured based, at least in part, on the size of the portion of the bearing 328 within the chamber 302 and the temperatures and related time profile of temperatures within the chamber 302 to which the bearing 328 will be subject.

Although the bearing 328 is shown in FIG. 5 as having a substantially uniform inner radius and outer radius, it should be understood that non-uniform values are possible. For example, in an embodiment, the bearing can have a uniform inner radius, and an outer radius for the portion of the bearing outside of the chamber 302 that is greater than an outer radius for the portion of the bearing inside of the chamber 302. In an alternative embodiment, the bearing can have a uniform inner radius, and an outer radius for the portion of the bearing outside of the chamber 302 that is less than an outer radius for the portion of the bearing inside of the chamber 302. In some embodiments, the inner radius of the bearing can be non-uniform, for example, to correspond to a non-uniform outer radius of the hollow cylindrical shaft 324. In some embodiments, both the inner radius and the outer radius of the bearing can be non-uniform, for example, accordingly to one or more of the embodiments mentioned above.

With respect to the illustrated embodiment of FIG. 5, the horizontal axis 306 is generally common to the housing 300, the cylindrical inside or inner surface 302, and the chamber 304. The horizontal axis 306 is also generally common to the cylindrical shaft 324 of the agitator 322 and is the axis of rotation of the agitator 322. The rear 308 and front 310 portions of the housing 300 are generally opposing circular end portions. The term “front” refers to a side at which a user views the roasting system 2 when it is in operation and can see a batch of beans being agitated inside the chamber 304. Opposing rear 330 and front 331 ends of the cylindrical shaft correspond to the opposing rear 308 and front 310 ends or portions of the housing 300.

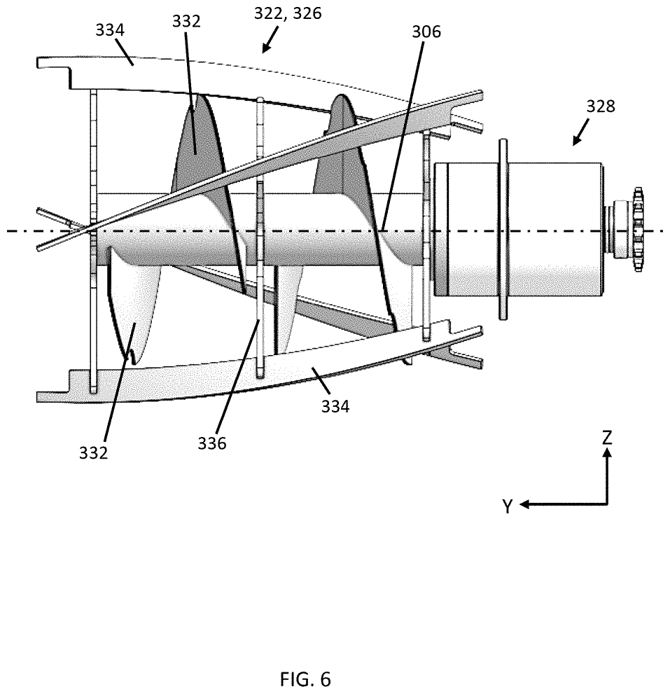

FIG. 6 is a side view of the agitator 322 and bearing 328 in isolation. The blade set 326 includes an inner helical auger 332. The blade set 326 also includes a set of outer blades 334 supported by radial spokes 336. As the agitator 322 rotates about the horizontal axis, the inner helical auger 332 imparts a horizontal motion of beans in the +Y direction (toward the door 318 or the front end portion 310 of the housing). At the same time, the outer blades 334 impart a motion of the beans in the −Y direction (toward the rear end portion 308 of the housing 300). The opposing directions of motion impartation mixes the beans during the roasting process, helping to provide a more uniform roasting. This motion impartation is also useful when the beans are unloaded from the chamber 304.

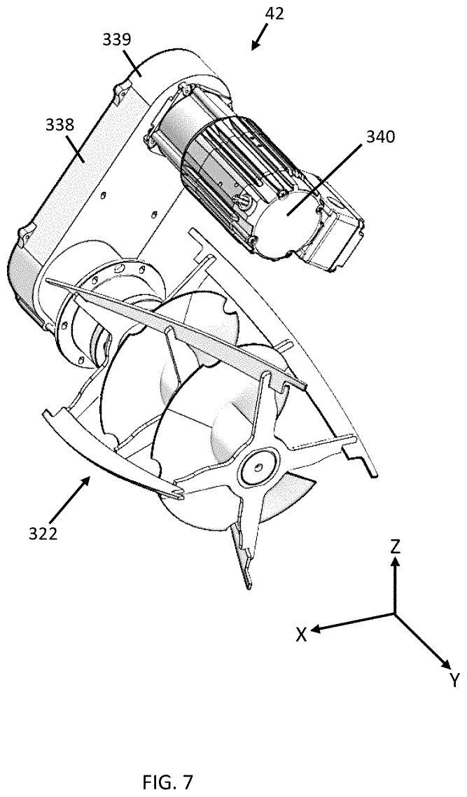

FIG. 7 is an isometric view of the agitator 322 and agitator actuator 42 in isolation. The agitator actuator 42 includes a power coupling 338 and motor 340. The power coupling 338 is coupled to the rear end portion 308 of the housing 300 (FIG. 4). The power coupling 338 includes a gear train or pully system (inside the illustrated housing 339) to provide rotational coupling from the motor 340 to the central shaft 324 of the agitator 322. In the illustrated embodiment, the motor 340 extends from the power coupling 338 in a frontward or +Y direction and overlaps with the housing along the horizontal Y-axis. This geometrical arrangement allows for a more compact overall geometry of the roasting subsystem 6.

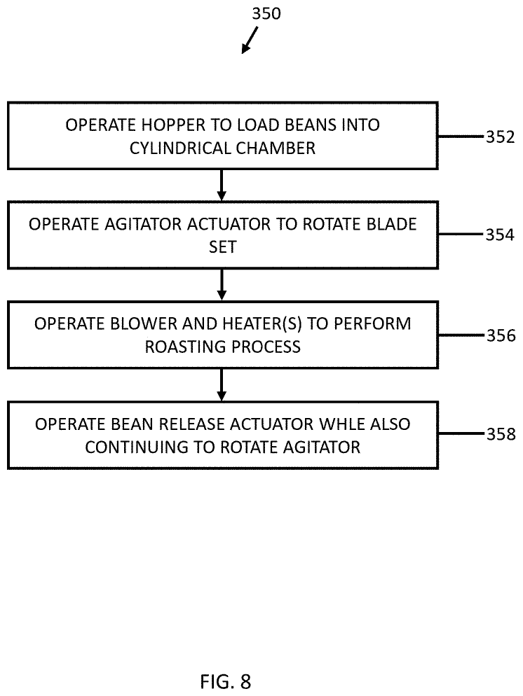

FIG. 8 is a flowchart of an embodiment of a method 350 of operating the bean roasting system 2. Method 350 is performed by controller 34. According to 352, the hopper 4 is operated to dispense a batch of beans into the roasting subsystem 6. The batch of beans passes from the hopper 4, through the second conduit 314, and into the inner chamber 304.

According to 354, the agitator actuator 42 is operated to rotate the actuator 322 about axis 306. According to 356, the air handling system 10 including heaters 12 and 17 and blower 16 are operated to provide heated air to the inner chamber 304 according to a bean roasting temperature versus time profile. During step 356, the heated air from the air handling system 10 enters the inner chamber 304 via first conduit 312 at an incoming velocity and then exits the inner chamber via second conduit 314 at an exit velocity that is of lower magnitude than the incoming velocity.

When the roasting process is complete, the bean release actuator 44 is activated to open the hatch 316 to release the beans from the roasting subsystem 6 to the bean cooling subsystem 8. While the hatch 316 is open, the agitator 322 continues to rotate. The outer blades 334 impart motion of the beans along the Y-axis to facilitate a more complete transfer of the batch of beans from the roasting subsystem 6 to the bean cooler 8.

The specific embodiments and applications thereof described above are for illustrative purposes only and do not preclude modifications and variations encompassed by the scope of the following claims.

What is claimed:

1. A bean roasting system, comprising:
a roasting subsystem including:
a housing having an inner surface defining an inner chamber for holding a batch of beans during a thermal roasting process, the inner chamber having a horizontal axis;
an agitator actuator;
an agitator coupled to the agitator actuator, the agitator includes a central shaft and a blade set mounted to the central shaft;
a door having a transparent window disposed at a front end portion of the housing; and
a bearing disposed at a rear end portion of the housing, the bearing supporting the central shaft and configured to prevent the blade set from contacting the inner surface of the housing and the door; and
an air handling subsystem coupled to the roasting subsystem, the air handling subsystem including a blower and a heater and configured to circulate heated air through the inner chamber during the thermal roasting process.

2. The bean roasting system of claim 1, wherein the housing includes:
a first conduit that defines an air inlet; and
a second conduit that defines an air outlet and a bean inlet.

3. The bean roasting system of claim 2, wherein the first conduit is located adjacent to the rear end portion of the housing and configured to receive heated air flow in a vertically downward direction from the air handling subsystem.

4. The bean roasting system of claim 3, wherein the second conduit is located adjacent to the front end portion of the housing and configured to output air flow in a vertically upward direction to the air handling subsystem.

5. The bean roasting system of claim 2, wherein the second conduit has a cross-sectional area greater than a cross-sectional area of the first conduit and configured to slow down a rate of airflow into the air handling subsystem in a upward direction to reduce entrainment of the batch of beans.

6. The bean roasting system of claim 1, wherein the housing includes a hatch, the blade set is configured to impart a stirring motion to the batch of beans to facilitate exit of the batch of beans through the hatch when the batch of beans is being unloaded from the chamber.

7. The bean roasting system of claim 1, wherein the blade set is configured to impart a circulating motion of beans of the batch of beans along the horizontal axis during rotation of the blade set.

8. The bean roasting system of claim 1, wherein the blade set includes:
an inner spiral auger configured to impart a horizontal motion of beans along a first horizontal direction during rotation of the blade set; and
an outer set of blades configured, during rotation of the blade set, to impart a horizontal motion of beans along a second horizontal direction that opposes the first horizontal direction to enhance mixing of the batch of beans during the thermal roasting process.

9. The bean roasting system of claim 1, wherein the central shaft is a hollow cylindrical shaft, the bearing radially surrounds the hollow cylindrical shaft at the rear end portion of the housing.

10. The bean roasting system of claim 1, wherein the agitator actuator includes a motor and a power coupling (1) mounted behind the rear end portion of the housing and (2) that is configured to transfer rotational power from the motor to the agitator.

11. The bean roasting system of claim 10, wherein the motor extends in a frontward direction from the power coupling and overlaps with the housing along the horizontal axis.

12. A bean roasting system, comprising:
a hopper;
a roasting subsystem including:
a housing having an inner surface defining an inner chamber for holding a batch of beans during a thermal roasting process, the inner chamber having a horizontal axis, the housing including a hatch coupled to a bean release actuator;
an agitator actuator;
an agitator coupled to the agitator actuator, the agitator includes a central shaft and a blade set mounted to the central shaft;
a bearing disposed at a rear end portion of the housing that supports the central shaft and is configured to prevent the blade set from contacting the inner surface of the housing; and
a door having a glass window disposed at a front end portion of the housing configured to allow viewing of the thermal roasting process;
an air handling subsystem coupled to the roasting subsystem, the air handling subsystem including a blower and a heater;
a bean cooling subsystem; and
a controller configured to:
operate the hopper to release the batch of beans from the hopper to the inner chamber;
operate the agitator actuator to rotate the actuator and to stir the batch of beans within the inner chamber;
operate the air handling subsystem to circulate heated air through the inner chamber according to the thermal roasting process; and
operate the bean release actuator and the agitator actuator to release beans from the inner chamber to the bean cooling subsystem.

13. The bean roasting system of claim 12, wherein the housing includes a first conduit and a second conduit, operating the air handling subsystem circulates the heated air into the first conduit and out of the second conduit, operating the hopper releases the beans from the hopper, through the second conduit, and to the inner chamber.

14. The bean roasting system of claim 13, wherein the second conduit has a larger cross area than the first conduit to provide a slower velocity of air leaving than entering the housing.

15. A method of roasting beans, comprising:
providing a hopper;
providing a roasting subsystem including:
a housing having an inner surface defining an inner chamber for holding a batch of beans during a thermal roasting process, the inner chamber having a horizontal axis, the housing including a hatch coupled to a bean release actuator;
an agitator actuator;
an agitator coupled to the agitator actuator, the agitator includes a central shaft and a blade set mounted to the central shaft;
a bearing disposed at a rear end portion of the housing that supports the central shaft and is configured to prevent the blade set from contacting the inner surface of the housing; and
a door having a glass window disposed at a front end portion of the housing and configured to allow viewing of the thermal roasting process;
providing an air handling subsystem coupled to the roasting subsystem, the air handling subsystem including a blower and a heater;
providing a bean cooling subsystem coupled to the roasting subsystem;
operating the hopper to release the batch of beans from the hopper to the inner chamber;
operating the agitator actuator to rotate the agitator and to stir the batch of beans within the inner chamber;
operating the air handling subsystem to circulate heated air through the inner chamber according to the thermal roasting process; and
operating the bean release actuator and the agitator actuator to release beans from the inner chamber to the bean cooling subsystem.

16. The method of claim 15, wherein:
the housing includes a first conduit and a second conduit,
operating the air handling subsystem circulates the heated air into the first conduit and out of the second conduit,
operating the hopper releases the beans from the hopper, through the second conduit, and to the inner chamber.

17. The method of claim 16, wherein the second conduit has a cross-sectional area greater than a cross-sectional area of the first conduit to provide a slower velocity of air leaving than entering the housing.

18. A method, comprising:
releasing a batch of beans from a hopper to an inner chamber of a housing having a (1) a hatch, (2) a door having a glass window disposed at a front end portion of the housing and configured to allow viewing of a thermal roasting process, (3) an agitator disposed within an interior of the inner chamber and having a rotatable shaft and a blade set coupled to the rotatable shaft, and (4) a bearing disposed at a rear end portion of the housing and supporting the rotatable shaft to prevent the blade set from contacting an inner surface of the inner chamber;
stirring, via the actuator, the batch of beans within the inner chamber;
circulating heated air through the inner chamber according to the thermal roasting process; and
releasing, via the hatch, beans from the inner chamber to a bean cooling subsystem.
